(19) United States
(12) Patent Application Publication
(10) Pub. No.: US 2026/0164080 A1
(43) Pub. Date: Jun. 11, 2026

(54) INFORMATION RECOMMENDATION METHOD, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Qingqing REN, Shenzhen (CN); Yunming HUANG, Shenzhen (CN); Shuyuan LI, Shenzhen (CN); Chuanyu ZHANG, Shenzhen (CN); Yanhua ZHAO, Shenzhen (CN); Zirui CHENG, Shenzhen (CN); Silin LIU, Shenzhen (CN); Guiyi YANG, Shenzhen (CN); Jinchao ZENG, Shenzhen (CN)

(21) Appl. No.: 19/181,644

(22) Filed: Apr. 17, 2025

Related U.S. Application Data
(63) Continuation of application No. PCT/CN2024/072285, filed on Jan. 15, 2024.

(30) Foreign Application Priority Data
Mar. 15, 2023 (CN) 202310286312.2

(51) Int. Cl. H04N 21/431; H04N 21/4725; H04N 21/81

(52) U.S. Cl. CPC H04N 21/4316; H04N 21/4725; H04N 21/812

(57) ABSTRACT

An information recommendation performed by an electronic device includes playing a video on a video playback interface; displaying a first bullet comment on the video playback interface, the first bullet comment carrying recommendation information; and playing a first material related to a plot of a first video segment on the video playback interface in response to a trigger operation for the first bullet comment, the first video segment being a video segment in the video corresponding to a display duration of the first bullet comment.

### CROSS-REFERENCES TO RELATED APPLICATIONS

This application is a continuation application of PCT Patent Application No. PCT/CN2024/072285, filed on Jan. 15, 2024, which claims priority to Chinese Patent Application No. 202310286312.2, filed on Mar. 15, 2023, all of which is incorporated herein by reference in their entirety.

### FIELD OF THE TECHNOLOGY

The present disclosure relates to the field of computer human-computer interaction technologies and, in particular, to an information recommendation method and apparatus, an electronic device, a computer-readable storage medium, and a computer program product.

### BACKGROUND OF THE DISCLOSURE

A bullet advertisement refers to an advertisement representation form in which content of an advertisement is displayed in a form of a bullet comment over a playing video on a screen. As an emerging advertisement representation form, the bullet advertisement has been used in some video websites.

However, the bullet advertisement is usually displayed in the form of a text or a picture. Only a font size, a color, a moving speed, a density, and the like of the text may be changed by a user, which cannot provide effective interaction between the user and the computer. This results in low efficiency and accuracy of information recommendation.

### SUMMARY

One embodiment of the present disclosure provides an information recommendation, performed by an electronic device. The method includes playing a video on a video playback interface; displaying a first bullet comment on the video playback interface, the first bullet comment carrying recommendation information; and playing a first material related to a plot of a first video segment on the video playback interface in response to a trigger operation for the first bullet comment, the first video segment being a video segment in the video corresponding to a display duration of the first bullet comment.

Another embodiment of the present disclosure provides an electronic device. The electronic device includes one or more processors; and a memory, configured to store an executable instruction that, when being executed, causes the one or more processors to perform: playing a video on a video playback interface; displaying a first bullet comment on the video playback interface, the first bullet comment carrying recommendation information; and playing a first material related to a plot of a first video segment on the video playback interface in response to a trigger operation for the first bullet comment, the first video segment being a video segment in the video corresponding to a display duration of the first bullet comment.

Another embodiment of the present disclosure provides a non-transitory computer-readable storage medium containing a computer-executable instruction that, when being executed, causes at least one processor to perform: playing a video on a video playback interface; displaying a first bullet comment on the video playback interface, the first bullet comment carrying recommendation information; and playing a first material related to a plot of a first video segment on the video playback interface in response to a trigger operation for the first bullet comment, the first video segment being a video segment in the video corresponding to a display duration of the first bullet comment.

### BRIEF DESCRIPTION OF THE DRAWINGS

FIG. 1 is a schematic architectural diagram of an information recommendation system 100 according to an embodiment of the present disclosure.

FIG. 2 is a schematic structural diagram of an electronic device 500 according to an embodiment of the present disclosure.

FIG. 3 is a schematic flowchart of an information recommendation method according to an embodiment of the present disclosure.

FIG. 4 is a schematic diagram of an application scene of an information recommendation method according to an embodiment of the present disclosure.

FIG. 5 is a schematic flowchart of an information recommendation method according to an embodiment of the present disclosure.

FIG. 6A to FIG. 6F are schematic diagrams of application scenes of an information recommendation method according to an embodiment of the present disclosure.

FIG. 7 is a schematic flowchart of an information recommendation method according to an embodiment of the present disclosure.

FIG. 8 is a schematic diagram of an implementation principle of a special effect animation according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, a term “some embodiments” involved describes subsets of all possible embodiments, but “some embodiments” may be the same subset or different subsets of all of the possible embodiments, and may be combined with each other without conflicts.

In the embodiments of the present disclosure, relevant data such as user information is involved. When the embodiments of the present disclosure are applied to a specific product or technology, user permission or consent needs to be obtained, and acquiring, use, and processing of the relevant data need to comply with relevant laws, regulations, and standards of relevant countries and regions.

In the following description, a term “first/second/ . . . ” involved is merely configured for distinguishing between similar objects and does not represent a specific order of objects. “first/second/ . . . ” may be transposed for a specific order or a sequence when allowed, so that embodiments of the present disclosure described herein can be implemented in an order other than those illustrated or described herein.

In the embodiments of the present disclosure, a term “module” or “unit” refers to a computer program having a predetermined function or a part of a computer program, and operates together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or an overall unit including a function of the module or the unit.

Unless otherwise defined, meanings of all technical and scientific terms used in the embodiments of the present disclosure are the same as those usually understood by a person skilled in the art to the terms belong. The terms used in the embodiments of the present disclosure are merely intended to describe objectives of the embodiments of the present disclosure, and are not intended to limit the present disclosure.

Before the embodiments of the present disclosure are further described in detail, a description is provided on nouns and terms in the embodiments of the present disclosure, and the nouns and terms in the embodiments of the present disclosure are applicable to the following explanations.
1) Bullet comment: It is content that pops up on a video playback interface. The content may come from different users, and is configured for making a comment on the video content, performing interaction based on the video content, or the like. For example, a user may make a comment on a screen while watching a video through a video playback platform, and the comment may appear on a video picture in real time in a form of scrolling marquee.
2) Bullet advertisement: It is an advertisement representation form in which content of an advertisement is displayed in a form of a bullet comment when a video is played, for example, an advertisement form in which text information or a picture may be displayed through a bullet comment in a movie and television drama.
3) In response to: It is configured for representing a condition or a state on which one or more to-be-performed operations depend. When the condition or the state is satisfied, the one or more to-be-performed operations may be real-time or have a set delay. Unless otherwise specified, a sequence in which a plurality of operations are performed is not limited.

When a video is played, an operator of a video application (APP) often needs to add various recommendation information (for example, advertisements) to a video, to display the recommendation information to users. A bullet advertisement is an advertisement representation form in which content of an advertisement is displayed in a form of a bullet comment when a video is played. As an emerging advertisement representation form, the bullet advertisement has been used in some video websites.

The bullet advertisement is usually displayed in the form of texts or pictures, and the user may only change a font size, a color, a moving speed, a density, and the like of the text. In addition, a display mode is usually full-length scrolling from right to left in a video playback frame. The display mode is relatively simple and lacks effective interaction with the user, resulting in a relatively weak conversion effect of the advertisement.

In view of this, the embodiments of the present disclosure provide an information recommendation method and apparatus, an electronic device, a computer-readable storage medium, and a computer program product, which can enrich the representation form of the bullet advertisement and implement bilateral interaction between the user and the advertisement, thereby increasing a conversion rate of the advertisement and enhancing user experience. The electronic device provided in the embodiments of the present disclosure is described below. The electronic device provided in the embodiments of the present disclosure may be implemented as a terminal device, or collaboratively implemented by a terminal device and a server. A description is provided below by using an example in which the server and the terminal device collaboratively implement the information recommendation method provided in the embodiments of the present disclosure.

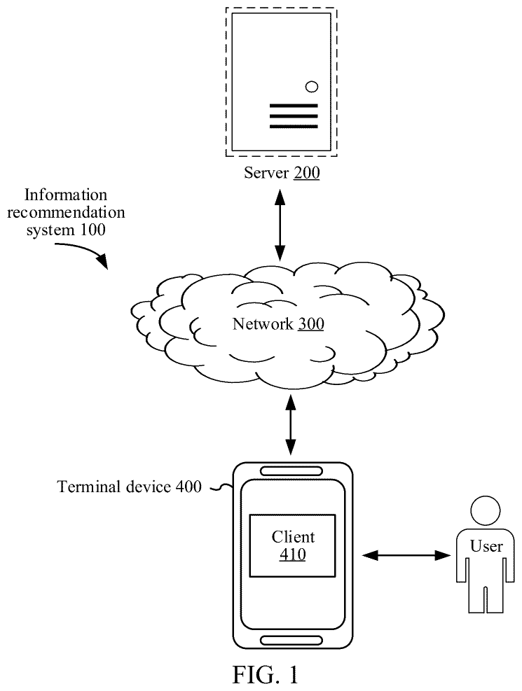

Exemplarily, FIG. 1 is a schematic architectural diagram of an information recommendation system 100 according to an embodiment of the present disclosure. To implement an application that supports and enriches a representation form of a bullet advertisement and then improves efficiency and accuracy of information recommendation, as shown in FIG. 1, the information recommendation system 100 includes a server 200, a network 300, and a terminal device 400. The network 300 may be a local area network, a wide area network, or a combination thereof. The terminal device 400 is a terminal device associated with a user. A client 410 is run on the terminal device 400. The client 410 may be various types of clients, for example, including a video playback client, a live streaming client, and a browser.

In some embodiments, an example in which the client 410 is the video playback client is made. In response to a video playback operation triggered by a user (for example, receiving a clicking/tapping operation performed by a user on a playback button), the client 410 transmit an obtaining request for to-be-played video data to the server through the network 300, so that the server 200 returns corresponding video data to the terminal device 400. Next, the client 410 may play a video on a video playback interface based on received video data. Subsequently, the client 410 may display a first bullet comment (such as a bullet advertisement) carrying recommendation information on the video playback interface in a process of playing the video. Finally, the client 410 may play a first material related to a plot of a first video segment on the video playback interface in response to the trigger operation (such as the clicking/tapping operation or a sliding operation) performed by the user on the first bullet comment. The first video segment is a video segment corresponding to a display duration of the first bullet comment in the video. In this way, a representation form of the bullet advertisement is enriched, and bilateral interaction between the user and the advertisement is implemented. thereby increasing a conversion rate of the advertisement and enhancing user experience.

In some other embodiments, this embodiment of the present disclosure may further be implemented through a cloud technology. The cloud technology is a hosting technology that unifies a series of resources such as hardware, software, and a network in a wide area network or a local area network to realize data computing, storage, processing, and sharing.

The cloud technology is a general term for a network technology, an information technology, an integration technology, a management platform technology, an application technology, and the like based on an application of a cloud computing business model, may form a resource pool, and may be used as required, which is flexible and convenient. A cloud computing technology becomes an important support. A background service of a technical network system requires a large amount of computing and storage resources.

Exemplarily, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 400 may be a smart phone, a tablet computer, a notebook computer, a desktop computer, a smart speaker, a smart watch, an on-board terminal, a virtual reality (VR) device, an augmented reality (AR) device, or the like, but is not limited thereto. The terminal device 400 and the server 200 may be directly or indirectly connected in a manner of wired or wireless communication, which is not limited in this embodiment of the present disclosure.

In some embodiments, the terminal device may implement the information recommendation method provided in the embodiments of the present disclosure by running various computer-executable instructions or computer programs. For example, the computer-executable instruction may be a microprogram-level command, a machine instruction, or a software instruction. For example, the computer program may be a native program or a software module in an operating system, may be a native APP, to be specific, a program that needs to be installed in the operating system to run, such as a live streaming APP or a video playback APP, may be an applet, to be specific, a program that only needs to be downloaded into a browser environment to run, or may further be an applet that can be embedded in any APP. In conclusion, the foregoing computer-executable instruction may be an APP in any form. The foregoing computer program may be an APP, a module, or a plug-in of any form.

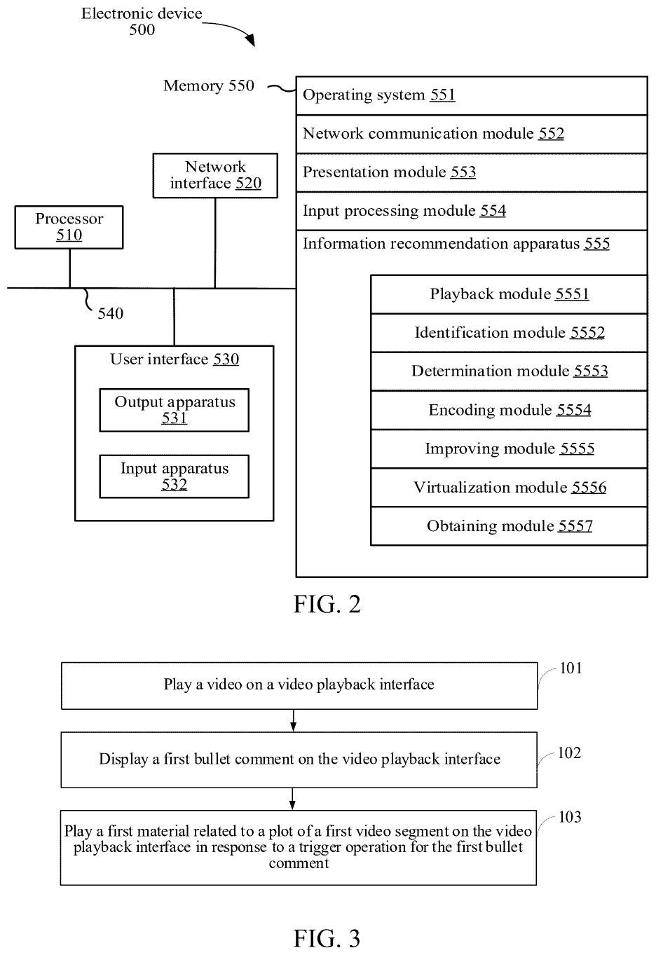

A structure of the electronic device provided in the embodiments of the present disclosure continues to be described below. An example in which the electronic device is a terminal device is used. FIG. 2 is a schematic structural diagram of an electronic device 500 according to an embodiment of the present disclosure. The electronic device 500 shown in FIG. 2 includes at least one processor 510, a memory 550, at least one network interface 520, and a user interface 530. All components in the electronic device 500 are coupled together through a bus system 540. The bus system 540 is configured to implement connection and communication between the components. In addition to a data bus, the bus system 540 further includes a power bus, a control bus, and a state signal bus. However, for ease of clear description, all types of buses in FIG. 2 are marked as the bus system 540.

The processor 510 may be an integrated circuit chip and has a signal processing capability, for example, a general purpose processor, a digital signal processor (DSP), or another programmable logical device, a discrete gate or a transistor logical device, or a discrete hardware component. The general purpose processor may be a microprocessor, any suitable processor, or the like.

The user interface 530 includes one or more output apparatuses 531 that enable presentation of media content, including one or more speakers and/or one or more visual display screens. The user interface 530 further includes one or more input apparatuses 532, including user interface components that facilitate user input, such as a keyboard, a mouse, a microphone, a touch screen display, a camera, and another input button and control.

The memory 550 may be removable, non-removable, or a combination thereof. An exemplary hardware device includes a solid-state memory, a hard disk driver, an optical disk driver, and the like. The memory 550 in some embodiments includes one or more storage devices that are physically located away from the processor 510.

The memory 550 may include a volatile memory or a non-volatile memory, or may include both a volatile memory and a non-volatile memory. The non-volatile memory may be a read-only memory (ROM), and the volatile memory may be a random access memory (RAM). The memory 550 described in the embodiments of the present disclosure is intended to include any suitable type of memory.

In some embodiments, the memory 550 can store data and support various operations. Examples of the data include a program, a module, and a data structure or a subset or a superset thereof. An exemplary description is provided below.

An operating system 551 includes system programs for processing various basic system services and performing hardware-related tasks, such as a framework layer, a kernel library layer, and a drive layer, and is configured to implement various basic services and process hardware-based tasks.

A network communication module 552 is configured to reach another computing device through one or more (wired or wireless) network interfaces 520. Exemplary network interfaces 520 include a Bluetooth interface, a wireless compatibility authentication (Wi-Fi) interface, a universal serial bus (USB) interface, and the like.

A presentation module 553 is configured to enable presentation of information (for example, a user interface for operation of a peripheral device and display of content and information) through one or more output apparatuses 531 (for example, a display screen and a speaker) associated with the user interface 530.

An input processing module 554 is configured to detect one or more user inputs or interactions from one of the one or more input apparatuses 532 and translate the detected inputs or interactions.

In some embodiments, an apparatus for resource processing provided in this embodiment of the present disclosure may be implemented by software. FIG. 2 shows an information recommendation apparatus 555 stored in the memory 550. The information recommendation apparatus may be software in the form of programs and plug-ins, including the following software modules: a playback module 5551, an identification module 5552, a determination module 5553, an encoding module 5554, an adjustment module 5555, a virtualization module 5556, and an obtaining module 5557. These modules are logical. Therefore, the modules may be combined or further split based on functions to be implemented by the modules. In FIG. 2, for ease of description, all the foregoing modules are shown at one time. However, it is not to be considered that the information recommendation apparatus 555 eliminates the implementation that only the playback module 5551 may be included. Functions of the modules are described below.

The information recommendation method provided in the embodiments of the present disclosure is described in detail below in combination with exemplary application and implementation of the terminal device provided in embodiments of the present disclosure.

Exemplarily, FIG. 3 is a schematic flowchart of an information recommendation method according to an embodiment of the present disclosure. A description is provided with reference to operations shown in FIG. 3.

The method shown in FIG. 3 may be performed by various forms of computer programs run by the terminal device, not limited to the client, and for example, may alternatively be the operating system, the software module, the script, and the applet described above. Therefore, the following examples of the client are not to be considered as a limitation on the embodiments of the present disclosure. In addition, for ease of description, the terminal device and the client running on the terminal device are not specifically distinguished in the following.

Operation 101: Play a video on a video playback interface.

In some embodiments, operation 101 may be implemented in the following manner: playing, in response to a video playback trigger operation, the video on the video playback interface. For example, a video playback button may be displayed on the video playback interface (for example, a video playback button may be displayed below the video playback interface). When a clicking/tapping operation performed by a user on the video playing button is received, the terminal device may transmit a video data obtaining request for a to-be-played video to a server, and play the video on the video playback interface after receiving video data returned by the server.

Operation 102: Display a first bullet comment on the video playback interface.

Herein, the first bullet comment may carry recommendation information (such as an advertisement). At least one of a moving speed, a size, and display effect parameters (such as a color and a font size) of the first bullet comment (such as a bullet advertisement) may be different from that of a second bullet comment. The second bullet comment is a bullet comment that does not carry the recommendation information (i.e., a common bullet comment). In other words, a display style of the bullet advertisement displayed on the video playback interface may be different from that of the common bullet comment, so as to attract a user to click/tap the bullet advertisement.

Exemplarily, an example in which the first bullet comment is the bullet advertisement is made. The moving speed of the bullet advertisement on the video playback interface may be less than that of the second bullet comment (i.e., a common bullet comment that does not carry advertisement content, for example, a bullet comment transmitted by another user watching a video), so as to avoid the user having no time to click/tap as a result of an excessively fast moving speed of the bullet advertisement. Alternatively, the size of the bullet advertisement may be larger than that of the second bullet comment. In other words, compared with the common bullet comment, the bullet advertisement displayed on the video playback interface is more visible and outstanding, so that attractiveness for the user can be increased. Alternatively, the color of the bullet advertisement may be different from that of the second bullet comment. For example, a chromatic color is applied for the bullet advertisement, and a white color is applied for the second bullet comment. In this way, it may be convenient for the user to quickly select the bullet advertisement from a plurality of bullet comments, to perform a trigger operation such as a click/tap or a slide on the bullet advertisement.

The first bullet comment may be transmitted by an operator of a video APP, or may be transmitted by a user (for example, a privileged user) watching the video, which is not specifically limited in embodiments of the present disclosure. In addition, the recommendation information carried in the first bullet comment may be an advertisement, or may be another type of information, for example, news or consultation information. Types of the recommendation information are not specifically limited in this embodiment of the present disclosure.

In some embodiments, operation 102 described above may be implemented in the following manner: displaying the first bullet comment starting from a first end (for example, a right side of the video playback interface) of the video playback interface in response to a playback progress of the video reaching a set time point, and gradually moving the first bullet comment toward a second end (for example, a left side of the video playback interface) of the video playback interface until being moved out of the video playback interface.

Exemplarily, an example in which the first bullet comment is the bullet advertisement is used. When it is detected that the playback progress of the video reaches the set time point (for example, a 10^{th} second), the bullet advertisement may be displayed starting from the right side of the video playback interface, and the bullet advertisement is controlled to gradually move toward the left side of the video playback interface until being moved out of the video playback interface.

For ease of clicking/tapping by the user, after the bullet advertisement is controlled to move to the left side of the video playback interface, the bullet advertisement may be controlled to stay on the left side of the video playback interface for a set duration (for example, 5 seconds), and then the bullet advertisement is controlled to move out of the video playback interface.

In addition, the server may pre-set, e.g., set in advance, at least one time point for each video, so that the terminal device transmits a bullet advertisement content request for a current time point to the server when detecting that a playback progress of a current video reaches each set time point, and displays a corresponding bullet advertisement on the video playback interface after receiving the bullet advertisement content returned by the server. Certainly, the terminal device may also transmit the bullet advertisement content request for a current set time point to the server before the playback progress of the video reaches the set time point (for example, 10 seconds ahead), namely, may also pre-load the bullet advertisement, which is not specifically limited in this embodiment of the present disclosure.

Exemplarily, for each video, the server may set the at least one time point in the video in the following manner: dividing the video into a plurality of video segments. For example, the video may be divided into a plurality of different video segments based on different scenes appearing in a video picture, and a time point is set in each video segment. In other words, a corresponding bullet advertisement may be displayed during playback of each video segment.

In some other embodiments, operation 102 described above may further be implemented in the following manner: displaying the first bullet comment starting from a first end of the video playback interface in response to a set scene appearing in a video, and gradually moving the first bullet comment toward a second end of the video playback interface until being moved out of the video playback interface, recommendation information carried in the first bullet comment being associated with the scene, and different scenes being associated with different recommendation information.

Exemplarily, an example in which the first bullet comment is the bullet advertisement is used. A trained scene identification model may be invoked to perform scene identification processing on a video (for example, the video may be identified frame by frame, or every set duration, for example, every 10 seconds). When it is detected that the set scene appears in the video, a bullet advertisement carrying an advertisement associated with a current scene may be displayed from a right side of a video playback interface, and the bullet advertisement is controlled to gradually move toward a left side of the video playback interface until being moved out of the video playback interface. For example, assuming that a scene appearing in the video is that a family is dining together, a bullet advertisement carrying a beverage advertisement may be displayed on a video playback interface. In this way, advertisement content carried in the bullet advertisement is associated with the scene appearing in the video, which can effectively reduce resistance of the user to the advertisement, thereby increasing a conversion rate of the advertisement.

A process of training the foregoing scene identification model is described below.

In some embodiments, the server may invoke an initialized scene identification model to perform prediction processing based on a sample video, to obtain a scene appearing in the sample video. Then the server may substitute a predicted scene and label data marked for the sample video (such as scene information marked for the sample video) into a loss function and perform back propagation processing, and update a parameter of the scene identification model during the back propagation process, to obtain the trained scene identification model. Subsequently, the server may transmit the trained scene identification model to the terminal device.

A structure of the foregoing scene identification model continues to be described below.

In some embodiments, an exemplary structure of the scene identification model may include an input layer (namely, an embedding layer), an encoding layer (for example, may be formed by a plurality of cascaded convolutional layers), a fully connected layer, and an output layer (including an activation function such as a softmax function). For example, several frames of the video (such as a plurality of frames extracted from a part of a video that has played) may be inputted into the input layer and embedding processing is performed. Next, encoding processing is performed on an embedding feature vector outputted by the input layer through the encoding layer, to obtain a hidden layer feature vector. Subsequently, full connection processing is performed on the hidden layer feature vector through the fully connected layer. Finally, a full connection result outputted by the fully connected layer is inputted into the output layer, to perform activation processing through the output layer, to obtain the scene appearing in the sample video.

The foregoing scene identification model may be a neural network model (for example, including a convolutional neural network, a deep convolutional neural network, or a fully connected neural network), a decision tree model, a gradient boosting tree, a multilayer perceptron, a support vector machine, or the like. A type of the scene identification model is not specifically limited in this embodiment of the present disclosure.

In some other embodiments, operation 102 described above may further be implemented in the following manner: displaying the first bullet comment starting from a first end of the video playback interface in response to appearance of a related object in the video that meets a matching condition with the recommendation information, and gradually moving the first bullet comment toward a second end of the video playback interface until being moved out of the video playback interface, the matching condition including: a label of the related object includes the keyword in the recommendation information, and a label of the related object includes the recommendation topic of the recommendation information.

Exemplarily, an example in which the first bullet comment is the bullet advertisement is used. An image identification model may be invoked to perform image identification processing on the video (for example, the video may be identified frame by frame, or identified every set duration, for example, identified every 10 seconds). When it is detected that the related object that meets the matching condition with the advertisement carried in the bullet advertisement appears in the video, for example, using an example in which the advertisement carried in the bullet advertisement is an ice cream advertisement, a corresponding recommendation topic may be delicacy, and when it is detected that an object related to delicacy (such as a dessert, a cake, or an ice cream, where labels corresponding to these objects are delicacy) appears in the video, the bullet advertisement carrying the ice cream advertisement may be displayed starting from the right side of the video playback interface, and the bullet advertisement is controlled to gradually move toward the left side of the video playback interface until being moved out of the video playback interface. In this way, because advertisement content carried in the bullet advertisement is related to the object appearing in the video, the bullet advertisement is not obtrusive, and the resistance of the user to the advertisement is reduced, thereby increasing a conversion rate of the advertisement and enhancing user experience.

The foregoing image identification model may be a neural network model (for example, including a convolutional neural network, a deep convolutional neural network, or a fully connected neural network), a decision tree model, a gradient boosting tree, a multilayer perceptron, a support vector machine, or the like. A type of the image identification model is not specifically limited in this embodiment of the present disclosure. In addition, to avoid a case of omission, the image identification model may be invoked to detect the video frame by frame. Certainly, to reduce resource consumption of the terminal device, the image identification model may also be invoked for detection once every set duration, which is not specifically limited in this embodiment of the present disclosure.

In some other embodiments, operation 102 described above may further be implemented in the following manner: playing the video starting from a set playback progress in response to a playback progress setting operation for a timeline of the video, displaying the first bullet comment starting from a first end of the video playback interface, and gradually moving the first bullet comment toward a second end of the video playback interface until being moved out of the video playback interface.

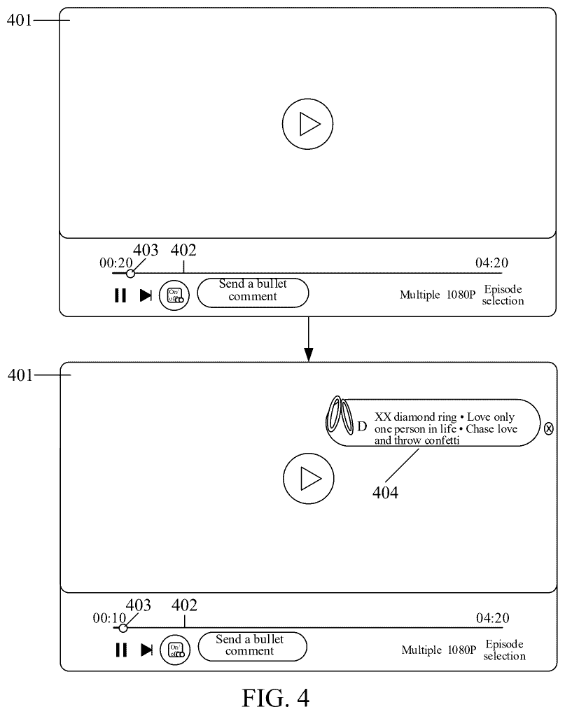

Exemplarily, an example in which the first bullet comment is the bullet advertisement is used. FIG. 4 is a schematic diagram of an application scene of an information recommendation method according to an embodiment of the present disclosure. As shown in FIG. 4, a timeline 402 of a currently played video is displayed on a video playback interface 401, and a button 403 that may be configured to adjust a playback progress is displayed on the timeline 402. It is assumed that a current playback progress of the video is a 20^{th} second, and then it is assumed that a dragging operation performed by a user on the button 403 displayed on the timeline 402 of the video is received. For example, assuming that the user drags the button 403 to a position corresponding to a 10^{th} second on the timeline 402, the video is replayed starting from the 10^{th} second, a bullet advertisement 404 is displayed starting from a right side of the video playback interface, and the bullet advertisement is controlled to gradually move toward a left side of the video playback interface until being moved out of the video playback interface. In this way, the bullet advertisement is displayed when the user repeatedly watches a certain wonderful video segment, which may increase the conversion rate of the advertisement while reducing resistance of the user to the advertisement.

Operation 103: Play a first material related to a plot of a first video segment on the video playback interface in response to a trigger operation for the first bullet comment.

Herein, the first material may be configured for supplementing a plot atmosphere of the first video segment. A type of the first material may include a picture, text, an emoticon, a virtual image, or the like.

One or more first materials may be displayed on the video playback interface. For example, a quantity of first materials displayed on the video playback interface may be dynamically adjusted based on an area of a blank area in a video picture that is currently played. For example, when it is detected that the video picture that is currently played includes a relatively small blank area, a relatively small first material may be displayed on the video playback interface. When it is detected that a relatively large blank area exists in the video picture that is currently played, a larger quantity of first materials may be displayed on the video playback interface. Certainly, the quantity of first materials displayed on the video playback interface may further be manually set by a user, which is not specifically limited in this embodiment of the present disclosure.

In addition, a display position of the first material on the video playback interface may be fixed. For example, the first material may be always displayed in a bottom area of the video playback interface. Certainly, the display position of the first material on the video playback interface may alternatively be dynamically adjusted. For example, the first material may move with movement of a person appearing in the video picture. Certainly, the display position of the first material on the video playback interface may further be set by the user. For example, the first material may be displayed at a position selected by the user on the video playback interface, which is not specifically limited in this embodiment of the present disclosure.

In some embodiments, an example in which the first bullet comment is a bullet advertisement is used. Assuming that a display duration of the bullet advertisement is from a 10^{th} second to a 15^{th} second, in other words, when the video is played to the 10^{th} second, the bullet advertisement appears on one side of the video playback interface. When the video is played to the 15^{th} second, the bullet advertisement exactly moves out from an other side of the video playback interface. In this case, when a trigger operation (for example, a clicking/tapping operation or a sliding operation) performed by the user on the bullet advertisement is received, the first material related to the plot of the first video segment (i.e., the video segment from the 10^{th} second to the 15^{th} second) may be played on the video playback interface. For example, if the plot of the first video segment is that a male protagonist confesses to a female protagonist, the first material may be a material in a petal falling style, to supplement the plot atmosphere of the first video segment, thereby implementing interaction between the advertisement and the video plot and improving watching experience of the user.

When the trigger operation performed by the user on the first bullet comment is received, a layer may also be newly added. The first material related to the plot of the first video segment is played in the newly added layer, and the layer may be superimposed on the video playback interface. In this way, an effect of playing the first material on the video playback interface can be achieved from a visual level.

In some other embodiments, following the foregoing example, the first material may be selected from a plurality of candidate materials. In this case, before the first material related to the plot of the first video segment is played, the following processing may further be performed: performing plot identification processing on the first video segment, to obtain plot information of the first video segment; and determining, from the plurality of candidate materials, the material (i.e., the first material for supplementing the plot atmosphere of the first video segment) that is consistent with the plot information of the first video segment.

Exemplarily, the performing plot identification processing on the first video segment, to obtain plot information of the first video segment may be implemented in the following manner: invoking a plot identification model to perform plot identification processing on the first video segment, to obtain the plot information of the first video segment. For example, an example in which the first video segment is a video segment 1 from the 10^{th} second to the 15^{th} second in the video is used. After the video segment 1 is captured from the video, a trained plot identification model may be invoked to perform plot identification processing on the video segment 1, to obtain plot information of the video segment 1. For example, assuming that a shot of kissing or flower sending occurs in the video segment 1, corresponding plot information may be that the male protagonist is confessing to the female protagonist or the two are dating.

The foregoing plot identification model may be a neural network model (for example, a convolutional neural network, a deep convolutional neural network, or a fully connected neural network), a decision tree model, a gradient boosting tree, a multilayer perceptron, a gradient lifting tree, a multilayer perceptron, a support vector machine, or the like. A type of the plot identification model is not specifically limited in this embodiment of the present disclosure.

Exemplarily, the determining, from a plurality of candidate materials, the first material that is consistent with the plot information of the first video segment may be implemented in the following manner: encoding styles of the plurality of candidate materials respectively, to obtain a style feature vector corresponding to each of the materials; encoding the plot information of the first video segment, to obtain a plot feature vector corresponding to the first video segment; sequentially determining a similarity between the plot feature vector corresponding to the first video segment and the style feature vector corresponding to each of the materials; and using a material corresponding to a highest similarity as a material (i.e., the first material) that is consistent with the plot information of the first video segment.

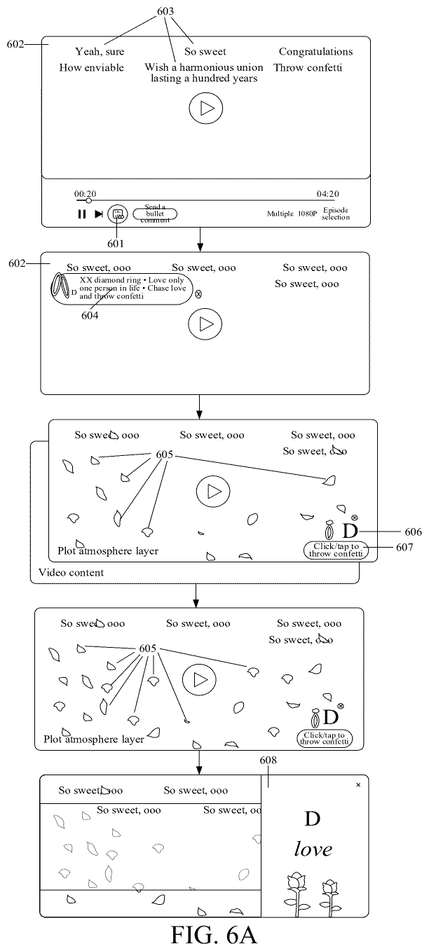

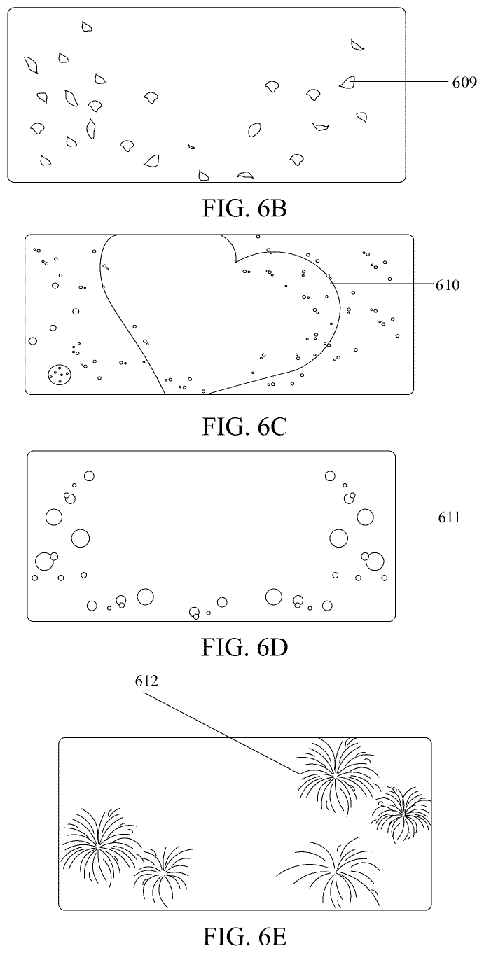

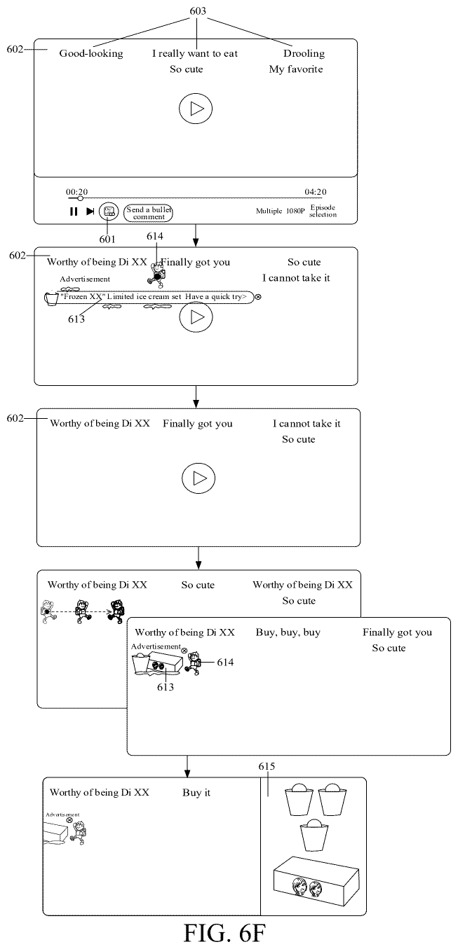

For example, the plurality of candidate materials being 4 materials is used as an example, it is assumed that the materials are respectively a material 1, a material 2, a material 3, and a material 4. A style of the material 1 may be a petal falling style shown in FIG. 6B, a style of the material 2 may be a light spot diverging style shown in FIG. 6C, a style of the material 3 may be a bubble rising style shown in FIG. 6D, and a style of the material 4 may be a firework blooming style shown in FIG. 6E. A model such as a multilayer perceptron or a convolutional neural network may be invoked to encode the styles of the 4 materials, to obtain a style feature vector corresponding to each material. Next, the model such as the multilayer perceptron or the convolutional neural network may continue to be invoked to encode plot information of the first video segment (for example, the video segment 1 from the 10^{th} second to the 15^{th} second in the video), to obtain a plot feature vector corresponding to the video segment 1. Subsequently, similarities between the plot feature vector corresponding to the video segment 1 and the style feature vectors respectively corresponding to the 4 materials may be calculated (for example, a two-norm or a Euclidean distance between the two feature vectors is calculated), and the material (assuming to be the material 1) corresponding to the highest similarity is used as a first material that is consistent with the plot information of the video segment 1. In other words, the material 1 is used as a material for supplementing a plot atmosphere of the video segment 1. In this way, because the style of the first material is associated with the plot of the first video segment, watching experience of the user can be enhanced, interaction between the user and the advertisement is promoted, thereby increasing a conversion rate of the advertisement.

In some embodiments, the first material may alternatively be extracted from the first video segment. In this case, before the first material related to the plot of the first video segment is played, the following processing may further be performed: identifying a target object from the first video segment, the target object including one of the following: an object that has occurred for a longest duration in the first video segment, an object that has occurred for most times (or most frequently) in the first video segment, and an object that has a largest quantity in the first video segment; and using at least one of the target object and a virtualized target object as the first material for supplementing the plot atmosphere of the first video segment.

Exemplarily, an example in which the first video segment is a video segment 1 from the 10^{th} second to the 15^{th} second in the video is used. An image identification model may be invoked to identify the target object from the video segment 1. The target object may be an object (for example, assuming that the object is a flower) that has occurred for a longest duration in the video segment 1 other than a character, or an object (for example, assuming that the object is a white cloud) that has occurred for most times in the video segment 1 other than the character, or an object (for example, assuming that the object is a tree) that has a largest quantity in the video segment 1. Subsequently, at least one of the target object or a virtualized target object may be used as the first material for supplementing the plot atmosphere of the video segment 1. In this way, the first material is associated with the plot of the video segment 1, and incoordination between the first material and video content may be avoided from the visual level, thereby effectively enhancing watching experience of the user.

For example, the target object being the flower is used as an example. The flower appearing in the video segment 1 may be directly used as a material (i.e., the first material) for supplementing the plot atmosphere of the video segment 1. Certainly, virtualization processing may also be performed on the flower, to obtain a virtualized flower, for example, a cartoonized flower, and the cartoonized flower is used as the material for supplementing the plot atmosphere of the video segment 1. In addition, the flower and the cartoonized flower may also be simultaneously used as materials for supplementing the plot atmosphere of the video segment 1, which is not specifically limited in this embodiment of the present disclosure. In some other embodiments, the first video segment may include a plurality of plot units. In this case, the playing the first material related to the plot of the first video segment may be implemented in the following manner: synchronously playing the first material on the video playback interface when different plot units of the first video segment are played, and applying, to the first material, a display effect parameter (for example, a parameter including a color, a size, or transparency) corresponding to the plot unit.

Exemplarily, an example in which the first video segment is a video segment 1 from a 10^{th} second to a 20^{th} second in the video is used. The video segment 1 may be divided into a plurality of plot units (for example, assuming that the video segment 1 is divided into 3 plot units, which are respectively a plot unit 1, a plot unit 2, and a plot unit 3) based on characters appearing in the video segment 1, topics discussed by the characters, or locations (for example, including indoors and outdoors). In this case, when different plot units of the video segment 1 are played, the first material is synchronously played on the video playback interface, and the display effect parameter (for example, including a quantity of materials, a size, a moving speed, or transparency) corresponding to a currently played plot unit is applied to the first material. For example, when the plot unit 1 in the video segment 1 is played, a quantity of first materials is 30, the moving speed is 5 m/s, and the transparency is 50%. When the plot unit 2 in the video segment 1 is played, the quantity of first materials is increased to 100, the moving speed is increased to 10 m/s, and the transparency is reduced to 30%. When the plot unit 3 in the video segment 1 is played, the quantity of first materials is reduced to 50, the moving speed is reduced to 6 m/s, and the transparency is increased to 60%. In this way, for different plot units in the first video segment, when the first material is played, different display effect parameters are applied, so that a display effect of the first material can change accordingly as the plot changes, which further enhances watching experience of the user.

In addition to that the first video segment may be divided into the plurality of plot units based on the characters that appear in the first video segment, the topics discussed by the characters, or the locations, the first video segment may further be divided into a plurality of stages based on time. For example, an example in which the first video segment is a video segment 1 from a 10^{th} second to a 40^{th} second in a video is used. The video segment 1 may be divided into 3 stages in advance. Assuming that a stage 1 corresponds to the 10^{th} second to a 20^{th} second in the video segment 1, a stage 2 corresponds to the 20^{th} second to a 30^{th} second in the video segment 1, and a stage 3corresponds to the 30^{th} second to the 40^{th} second in the video segment 1, a display effect parameter corresponding to a current stage is applied to the first material when the first material is played. Different stages correspond to different display effect parameters. For example, assuming that the stage 1 of the video segment 1 is played, a quantity of first materials is 30, and transparency is 50%. When the stage 2 of the video segment 1 is played, the quantity of first materials is increased to 100, and the transparency is reduced to 30% (i.e., the display effect of the first material being improved). When the stage 3 of the video segment 1 is played, the quantity of first materials is reduced to 20, and the transparency is increased to 60%. In this way, for different stages of the first video segment, different display effect parameters are applied to the first material when the first material is played synchronously, thereby further enriching a representation form of the first material, and enhancing watching experience of the user.

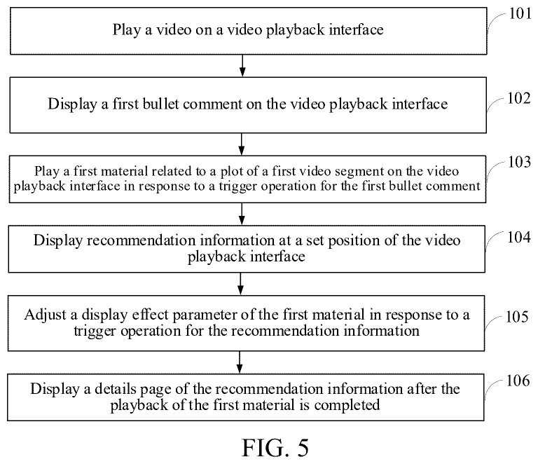

In some other embodiments, FIG. 5 is a schematic flowchart of an information recommendation method according to an embodiment of the present disclosure. As shown in FIG. 5, after operation 103 shown in FIG. 3 is performed, operation 104 to operation 106 shown in FIG. 5 may be further performed. A description is provided with reference to operations shown in FIG. 5.

Operation 104: Display recommendation information at a set position of the video playback interface.

In some embodiments, the recommendation information carried in the first bullet comment may be displayed at the set position (for example, a lower right corner) of the video playback interface after the first bullet comment is moved out of the video playback interface.

Exemplarily, an example in which the first bullet comment is a bullet advertisement is used. When a display condition is met, the bullet advertisement may be controlled to display starting from one end of the video playback interface, and gradually move toward an other end of the video playback interface. Advertisement content carried in the bullet advertisement may be displayed at the lower right corner of the video playback interface after the bullet advertisement is moved out of the video playback interface, to implement secondary exposure of the advertisement.

Operation 105: Adjust a display effect parameter of the first material in response to a trigger operation for the recommendation information.

In some embodiments, the adjusting a display effect parameter of the first material may be implemented in the following manner: performing at least one of the following processes: increasing a quantity of first materials displayed on the video playback interface; increasing a moving speed of the first material on the video playback interface; reducing transparency of the first material on the video playback interface; and increasing a size (including e.g., an area) of the first material displayed on the video playback interface.

Exemplarily, an example in which the first bullet comment is the bullet advertisement is used. After the bullet advertisement is moved out of the video playback interface, the advertisement content carried in the bullet advertisement and an interactive button (for example, a button of “clicking/tapping to throw confetti”) associated with the advertisement content may be displayed at the lower right corner of the video playback interface. When a clicking/tapping operation performed by the user on the interactive button is received, the display effect parameter of the first material played on the video playback interface may be adjusted. For example, the quantity of first materials may be increased on the video playback interface, or the moving speed of the first material may be increased, or the transparency of the first material may be reduced. In this way, interaction between the user and the advertisement can be promoted. Further, the conversion rate of the advertisement is increased.

Operation 106: Display a details page of the recommendation information after the playback of the first material is completed.

In some embodiments, after it is detected that the playback of the first material is completed, the details page of the recommendation information may be automatically displayed on the video playback interface, to facilitate the user to purchase. Certainly, to avoid affecting watching of the video by the user, the details page of the recommendation information may alternatively be displayed in a split-screen manner. For example, the details page of the recommendation information may be displayed in an area independent of the video playback interface. A display manner of the details page of the recommendation information is not limited in this embodiment of the present disclosure.

Exemplarily, FIG. 6A is a schematic diagram of an application scene of an information recommendation method according to an embodiment of the present disclosure. As shown in FIG. 6A, when a playback progress of a video reaches a set time point, a bullet advertisement 604 may be displayed on a video playback interface 602. When a clicking/tapping operation of a user on the bullet advertisement 604 is received, a first material 605 associated with a plot of the first video segment may be displayed on the video playback interface. For example, when the plot of the first video segment is that a male protagonist confesses to a female protagonist, the first material 605 may be a material in a petal falling style, to supplement a plot atmosphere of the first video segment. In addition, after the bullet advertisement 604 is moved out of the video playback interface, advertisement content 606 carried in the bullet advertisement 604 and an interactive button (for example, a button 607 of “clicking/tapping to throw confetti”) associated with the advertisement content 606 are displayed at a lower right corner of the video playback interface. When a clicking/tapping operation performed by the user on the button 607 of “clicking/tapping to throw confetti” is received, a display effect of the first material 605 displayed on the video playback interface may be enhanced, for example, transparency of the first material 605 is reduced, or a moving speed of the first material 605 is increased. Subsequently, the first material 605 is controlled to gradually disappear, and a details page 608 of the advertisement is automatically displayed.

When a trigger operation performed by the user on a first bullet comment is received, in addition to playing the first material on the video playback interface, a details page of recommendation information may further be displayed, which is not specifically limited in this embodiment of the present disclosure.

In some other embodiments, a type of the first material may alternatively be a virtual image. In this case, the playing a first material related to a plot of a first video segment on the video playback interface may further be implemented in the following manner: playing the virtual image related to the plot of the first video segment on the video playback interface, a display mode of the virtual image including a static display mode and a dynamic display mode.

Exemplarily, an example in which the first bullet comment is the bullet advertisement is used. When a clicking/tapping operation performed by the user on the bullet advertisement is received, the virtual image related to the plot of the first video segment may be played on the video playback interface. The virtual image may be associated with an advertisement carried in the bullet advertisement, and the advertisement is related to the plot of the first video segment. For example, assuming that the plot of the first video segment is that a family is dining together, the corresponding advertisement may be a beverage advertisement. The virtual image may be an intellectual property (IP) image of an advertisement brand configured by an advertiser for an advertisement. Certainly, the virtual image may also be associated with a video plot. For example, the virtual image may be a virtual object extracted from a video. In addition, the display mode of the virtual image may be the static display mode. For example, the virtual image may be a static image. Certainly, the display mode of the virtual image may also be the dynamic display mode. For example, the virtual image may also be an animation.

Assuming that in a process of playing the virtual image, a trigger operation (such as a clicking/tapping operation or a slide operation) performed by the user on the virtual image is received, the details page of recommendation information may be displayed. The details page of the recommendation information may be suspended on the video playback interface, or may be displayed independent of the video playback interface in a split-screen manner. A display manner of the details page of the recommendation information is not specifically limited in this embodiment of the present disclosure.

In some other embodiments, the virtual image may be obtained from the first video segment. In this case, before the virtual image related to the plot of the first video segment is played, the following processing may further be performed: identifying a target object from the first video segment, the first video segment being a video segment in the video corresponding to a display duration of the first bullet comment; and virtualizing the target object, to obtain the virtual image, the target object including one of the following: an object that has occurred for a longest duration in the first video segment, an object that has occurred for most times in the first video segment, and an object that has a largest quantity in the first video segment.

Exemplarily, an example in which the first video segment is a video segment 1 from a 10^{th} second to a 15^{th} second in the video is used. After the video segment 1 is segmented from the video, an image identification model may be invoked to identify the target object from the video segment 1. The target object may be an object (for example, assuming that the object is a flower) that has occurred for a longest duration in the video segment 1 other than a character. Certainly, the target object may alternatively be a target (for example, assuming that the object is a chicken) that has occurred for most times in the video segment 1 other than a character. In addition, the target object may alternatively be an object (for example, assuming that the object is a tree) that has a largest quantity in the video segment 1. After the target object is identified from the video segment 1, virtualization processing may be performed on the identified target object, to obtain the virtual image. For example, an example in which the target object is the chicken is used. Virtualization processing may be performed on a chicken identified from the video segment 1, to obtain a cartoonized chicken, and the cartoonized chicken is used as a virtual image related to the plot of the video segment 1. In this way, the virtual image is associated with the plot of the first video segment, and watching experience of a user can be effectively enhanced.

In some embodiments, the virtual image may alternatively be obtained based on the recommendation information. In this case, before the virtual image related to the plot of the first video segment is played, the following processing may further be performed: obtaining feature information of the recommendation information, the recommendation information being related to the plot of the first video segment, the feature information including at least one of a keyword and a recommendation topic of the recommendation information; and obtaining the virtual image with the feature information of the recommendation information as a label, different virtual images being pre-associated with different labels.

Exemplarily, an example in which the first bullet comment is the bullet advertisement is used. Before the virtual image related to the plot of the first video segment is played, feature information of an advertisement carried in the bullet advertisement may be first obtained. The advertisement is related to the plot of the first video segment. For example, assuming that the plot of the first video segment is that a family is dining together, the corresponding advertisement may be a beverage advertisement. For example, a keyword of an advertisement and a recommendation topic may be obtained. Next, a matching target virtual object, for example, a virtual image whose label is cute or delicacy, may be obtained from the plurality of candidate virtual images based on at least one of the obtained keyword (for example, assuming to be cute) of the advertisement or recommendation topic (for example, assuming to be delicacy). In this way, because the virtual image is associated with the recommendation information, coordination between the virtual image and the recommendation information carried in the first bullet comment is improved, thereby improving watching experience of the user.

The foregoing recommendation topic may be obtained by extracting a keyword of the recommendation information. For example, when the recommendation information has a plurality of keywords, any keyword randomly extracted from the plurality of keywords may be used as the recommendation topic of the recommendation information.

According to the information recommendation method provided in this embodiment of the present disclosure, in a process of playing the video, the first bullet comment (for example, the bullet advertisement) is displayed on the video playback interface, and after the trigger operation performed by the user on the bullet advertisement is identified, the first material related to the plot of the first video segment is displayed on the video playback interface, thereby enriching the representation form of the bullet advertisement, achieving an effect of mutual correlation between the advertisement and the video plot, and promoting bilateral interaction between the user and the advertisement. In other words, in this embodiment of the present disclosure, a failure rate of information recommendation is reduced by enriching the representation form of the bullet advertisement, thereby avoiding ineffective recommendation, and then increasing a conversion rate of the advertisement and enhancing user experience.

An exemplary application of this embodiments of the present disclosure in an actual application scene is described below by using an example in which the first bullet comment is the bullet advertisement.

An embodiment of the present disclosure provides a new advertisement form in which a special effect (corresponding to the foregoing first material) is generated by interacting with the bullet advertisement. The special effect may be associated with the video plot, so as to achieve an effect of mutual correlation between the bullet advertisement and the video plot. An operation behavior such as tapping/clicking or sliding performed by the user on the bullet advertisement is identified through a terminal device (for example, a mobile phone associated with the user), to trigger display of a special effect, thereby enriching the representation form of the bullet advertisement, implementing the bilateral interaction between the user and the advertisement, and improving a representation effect of a brand advertisement. In addition, from a perspective of launching the advertisement, in this embodiment of the present disclosure, launch time of the bullet advertisement may further be properly arranged. For example, a bullet advertisement that can interact with a plot is launched in a scene matching a product feature in a video, so that an advertisement is correlated with video content. As a result, a distance between the advertisement and an audience is easier to be shortened, and an interest of a user in participating in an interaction is improved, thereby improving a click/tap rate, an interaction rate, and a conversion rate of the advertisement.

The information recommendation method provided in the embodiments of the present disclosure is described in detail below.

In some embodiments, a user may trigger an atmosphere special effect (corresponding to the above-described first material) by clicking/tapping the bullet advertisement, to implement plot interaction.

Exemplarily, FIG. 6A is a schematic diagram of an application scene of an information recommendation method according to an embodiment of the present disclosure. As shown in FIG. 6A, when a video is watched on a video playback platform, a user needs to turn on a bullet comment display 601, so that while video content is played in a video playback interface 602, a bullet comment 603 transmitted by another user may be displayed. When the video content is played to a specific time point or scene, the bullet advertisement 604 may be displayed on the video playback interface 602. For example, the bullet advertisement 604 may appear from the right side of the video playback interface 602, gradually move to a left side of the video playback interface 602, and stay on the left side for N seconds (for example, 10 seconds). When the clicking/tapping operation performed by the user on the bullet advertisement 604 is received (for example, when a clicking/tapping operation performed by the user on a button of “chasing love and throwing confetti” in the bullet advertisement 604 is received), an atmosphere special effect 605 in a petal falling style may be displayed on the video playback interface 602. For example, the atmosphere special effect may be displayed in a plot atmosphere layer, and the plot atmosphere layer is superimposed on the video playback interface. When the clicking/tapping operation performed by the user on the bullet advertisement 604 is not received, display of the bullet advertisement 604 may be canceled after being displayed for N seconds, advertisement content 606 (for example, advertisement content that has been reduced) carried in the bullet advertisement 604 is displayed at a lower right corner of the video playback interface, and the atmosphere special effect 605 is automatically displayed on the video playback interface. Subsequently, when the clicking/tapping operation performed by the user on the interactive button (for example, the button 607 of “clicking/tapping to throw confetti”) of the advertisement displayed on the lower right corner of the video playback interface 602 is received, a display effect of the atmosphere special effect 605 displayed on the video playback interface may be enhanced (for example, a quantity of petals in the atmosphere special effect 605 is increased, or a moving speed of the petals in the atmosphere special effect 605 is increased). In addition, after the atmosphere special effect 605 is displayed (for example, the atmosphere special effect 605 is controlled to gradually disappear), a details page 608 of the advertisement is automatically displayed.

When a clicking/tapping operation performed by the user on advertisement content carried in the bullet advertisement 604 is received, the details page 608 of the advertisement may be directly jumped to. In addition, a material style of the atmosphere special effect may be a petal falling style 609 shown in FIG. 6B, a light spot diverging style 610 shown in FIG. 6C, a bubble rising style 611 shown in FIG. 6D, or a firework blooming style 612 shown in FIG. 6E. A special effect atmosphere that is consistent with a form of a plot may be displayed on the video playback interface based on a current video plot. For example, assuming that a current video plot is that a male protagonist confesses to a female protagonist, after the user clicks/taps the bullet advertisement, the atmosphere special effect of the petal falling style may be displayed, to supplement the atmosphere.

In some other embodiments, the user may also trigger an IP image (corresponding to the foregoing virtual image) by clicking/tapping the bullet advertisement, to implement plot interaction.

Exemplarily, FIG. 6F is a schematic diagram of an application scene of an information recommendation method according to an embodiment of the present disclosure. As shown in FIG. 6F, when a video is watched on a video playback platform, a user needs to turn on a bullet comment display 601, so that while video content is played in a video playback interface 602, a bullet comment 603 transmitted by another user may be displayed. When the video content is played to a specific time point or scene, a bullet advertisement 613 may be displayed on the video playback interface 602. When a clicking/tapping operation performed by a user on the bullet advertisement 613 is received, an IP image 614 (a material format of the IP image may be a static image or an animation) of an advertisement brand may be displayed. After being displayed on the video playback interface 602 for N seconds (for example, 10 seconds), the bullet advertisement 613 may move out of a screen in a movement direction of a common bullet comment. In addition, when the bullet advertisement disappears for M seconds (for example, 6 seconds), the IP image 614 of the advertisement brand may be displayed again on the video playback interface, and the bullet advertisement 613 is pushed out again, so that the advertisement is exposed again. Subsequently, when the clicking/tapping operation performed by the user on the bullet advertisement 613 or the IP image 614 is received, a details page 615 of the advertisement may be displayed on the screen.

The IP image 614 of the advertisement brand may also be displayed together with the bullet advertisement 613. In addition, an interaction manner for the bullet advertisement in this embodiment of the present disclosure includes, but is not limited to, clicking, sliding, shaking, flipping, leaning, pinching, and the like. In addition, a representation form of a special effect in this embodiment of the present disclosure may use a plurality of methods and forms such as VR, AR, and a 3-dimension (3D) animation.

In some embodiments, after the user enters a details page of a certain video, a terminal device associated with the user may initiate a corresponding marked position request of the bullet advertisement to a server. After receiving the request, the server may query a corresponding video identifier (VID, Video ID) for a marked position (corresponding to the foregoing set time point). If the VID has corresponding bullet advertisement dotting information, the dotting information is returned to the terminal device. The terminal device plays a video feature after receiving the marked position information returned by the server. When a feature playback progress reaches a time point that is N seconds (for example, 10 seconds, where an advanced amount may be changed through a configuration system) prior to a marked position, the terminal device may initiate a detailed bullet advertisement content request of the position to the server. The server retrieves corresponding bullet advertisement content based on the marked position, and returns the content to the terminal device. In addition, the video feature is played all the time. When the feature playback progress reaches the marked position, the terminal device checks whether the bullet advertisement content exists in this case, and displays the bullet advertisement the bullet advertisement content exists. A display mode of the bullet advertisement is the same as that of the common bullet comment, which rolls from one side of the screen to an other side based on a velocity configured by the bullet comment. If no bullet advertisement content exists or after a current bullet advertisement is displayed, whether a next marked position exists is checked. If the marked position exists, a next cycle of marked position processing is entered, and if no marked position exists, the process ends.

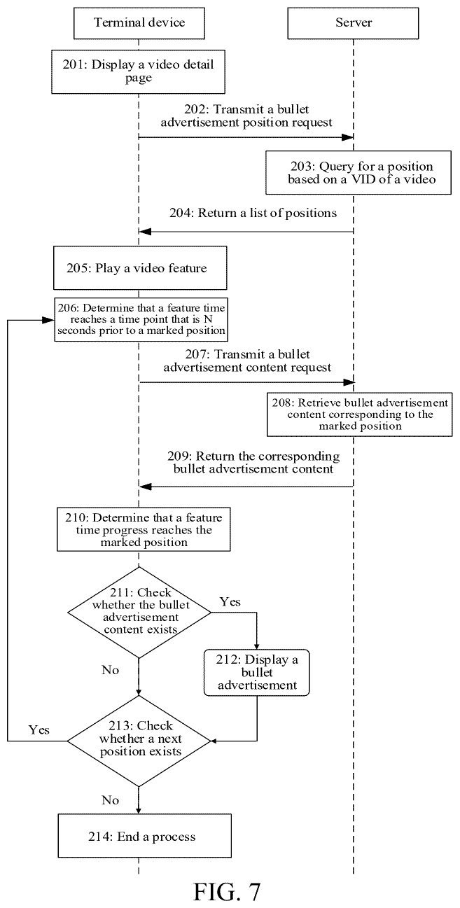

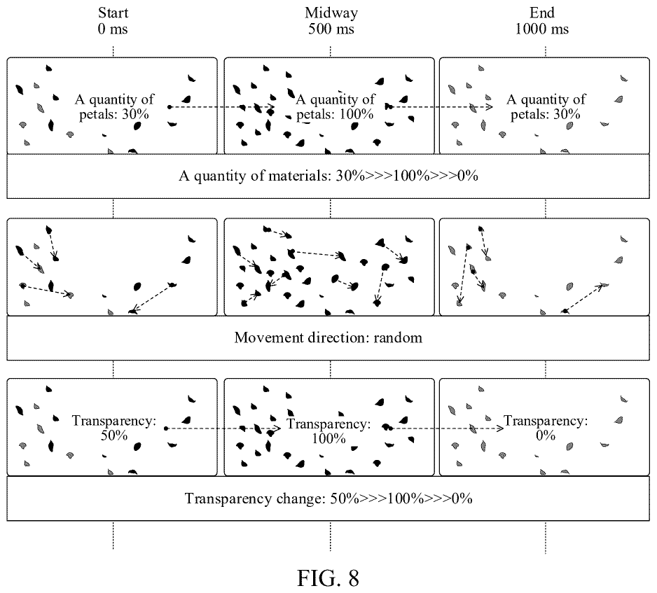

Exemplarily, FIG. 7 is a schematic flowchart of an information recommendation method according to an embodiment of the present disclosure. A description is provided with reference to operations shown in FIG. 7.

Operation 201: A terminal device displays a video details page.

Operation 202: The terminal device transmits a bullet advertisement position request to a server.

Operation 203: The server queries for a position based on a VID of a video.

Operation 204: The server returns a list of positions to the terminal device.

Operation 205: The terminal device plays a video feature.

Operation 206: The terminal device determines that a feature time reaches a time point that is N seconds prior to a marked position.

Operation 207: The terminal device transmits a bullet advertisement content request to the server.

Operation 208: The server retrieves bullet advertisement content corresponding to the marked position.

In some embodiments, the bullet advertisement content may include a copy, a picture, special effect content, and the like.

Operation 209: The server returns the corresponding bullet advertisement content to the terminal device.

Operation 210: The terminal device determines that a feature time progress reaches the marked position.

Operation 211: The terminal device checks whether the bullet advertisement content exists, performs operation 212 if the bullet advertisement content exists, and performs operation 213 if the bullet advertisement content does not exist.

Operation 212: The terminal device displays a bullet advertisement.

In some embodiments, the bullet advertisement provided in this embodiment of the present disclosure supports user interaction, and can generate a corresponding interaction effect in combination with the advertisement. The foregoing display and interaction effects may be implemented through a special bullet comment and a layer transformation animation. This special bullet comment (i.e., the bullet advertisement) refers to a bullet comment as a blend of a picture and a supported rich text which is generated by inserting a picture in a form of an icon and the rich text at any position of a conventional plain-text bullet comment. The terminal device triggers display of a special effect by identifying a behavior such as tapping/clicking or sliding performed by the user on the bullet advertisement.

Exemplarily, FIG. 8 is a schematic diagram of an implementation principle of a special effect animation according to an embodiment of the present disclosure. As shown in FIG. 8, a layer density may be controlled by a variable v, and may be changed (for example, increased or decreased) through an interactive button of an advertisement. At time T after the special effect is displayed, a quantity L of randomly generated layers is n*v, a position P (x, y)=(random ()% screenWidth, random ()% screenHeight), a size S (x)=random ()% 100/100. f*rawScale, and a transparency O (x)=random ()% 100/100. f*rawOpacity of a special effect material, where n is a variable greater than 1, random () represents a random function, screenWidth represents a screen width (i.e., a width of a video playback interface), screenHeight represents a screen height (i.e., a height of the video playback interface), rawScale represents an original size of the special effect material, and rawOpacity represents original transparency of the special effect material. Next, after the time N, i.e., after time T'=T+N, an operation performed at the time T is repeated. In this way, different layers can be generated at different times, and a position, a size, and transparency of a layer generated at a previous time T may be randomly changed, so as to achieve an effect of a random animation special effect.

Operation 213: The terminal device checks whether a next position exists, performs operation 206 if the next position exists, and performs operation 214 if the next position does not exist.

Operation 214: The terminal device ends the process.

Based on the above, the information recommendation method provided in this embodiment of the present disclosure has the following beneficial effects:
(1) From a perspective of an advertiser, the technical solution provided in this embodiment of the present disclosure can help brand advertising establish popularity, cultivate favorability of a user for a brand, and enhance a marketing conversion effect.
(2) From a perspective of a user, the technical solution provided in this embodiment of the present disclosure can fully arouse curiosity of the user, and drive the user to actively choose to watch an advertisement, which reduces subjective rejection of the user for the advertisement, and realizes two-way communication between the brand and an audience.
(3) From a perspective of an advertising strategy, through analysis of behavior data generated by participation of the user in interaction, preference reference of a consumer is provided for the brand, and guidance and suggestions are provided for a brand launch strategy.
(4) From a perspective of a video playback platform, the technical solution provided in this embodiment of the present disclosure can bring an interactive experience, thereby increasing fun of a video plot and enhancing watching experience of the user.

An exemplary structure of an information recommendation apparatus 555 provided in the embodiments of the present disclosure implemented as a software module is further described below. In some embodiments, as shown in FIG. 2, software modules in the information recommendation apparatus 555 stored in the memory 550 may include a playback module 5551.

The playback module 5551 is configured to play a video on a video playback interface. The playback module 5551 is further configured to display a first bullet comment on the video playback interface, the first bullet comment carrying recommendation information. The playback module 5551 is further configured to play a first material related to a plot of a first video segment on the video playback interface in response to a trigger operation for the first bullet comment, the first video segment being a video segment in the video corresponding to a display duration of the first bullet comment.

In some embodiments, the information recommendation apparatus 555 further includes an identification module 5552, which is configured to perform, before a first material related to a plot of the first video segment is played by the playback module 5551, plot identification processing on the first video segment, to obtain plot information of the first video segment. The information recommendation apparatus 555 further includes a determination module 5553, which is configured to determine, from a plurality of candidate materials, the first material that is consistent with the plot information.

In some embodiments, the information recommendation apparatus 555 further includes an encoding module 5554, which is configured to encode styles of the plurality of candidate materials respectively, to obtain a style feature vector corresponding to each of the materials. The encoding module 5554 is further configured to encode the plot information of the first video segment, to obtain a plot feature vector corresponding to the first video segment. The determination module 5553 is further configured to: sequentially determine a similarity between the plot feature vector corresponding to the first video segment and the style feature vector corresponding to each of the materials; and use a material corresponding to a highest similarity as the first material that is consistent with the plot information.

In some embodiments, the identification module 5552 is further configured to identify, before the first material related to the plot of the first video segment is played by the playback module 5551, a target object from the first video segment, the target object including one of the following: an object that has occurred for a longest duration in the first video segment, an object that has occurred for most times in the first video segment, and an object that has a largest quantity in the first video segment. The determination module 5553 is further configured to use at least one of the target object and a virtualized target object as the first material related to the plot of the first video segment.

In some embodiments, after the first bullet comment is moved out of the video playback interface, the playback module 5551 is further configured to display the recommendation information at a set position of the video playback interface. The information recommendation apparatus 555 further includes an adjustment module 5555, which is configured to improve a display effect parameter of the first material in response to a trigger operation for the recommendation information. The playback module 5551 is further configured to display a details page of the recommendation information after the playback of the first material is completed.

In some embodiments, the adjustment module 5555 is further configured to perform at least one of the following processes: increasing a quantity of first materials displayed on the video playback interface; increasing a moving speed of the first material on the video playback interface; reducing transparency of the first material on the video playback interface; and increasing a size of the first material displayed on the video playback interface.

In some embodiments, the first video segment includes a plurality of plot units. The playback module 5551 is further configured to synchronously play the first material on the video playback interface when different plot units of the first video segment are played, and apply, to the first material, a display effect parameter corresponding to the plot unit.

In some embodiments, the first material includes a virtual image. The playback module 5551 is further configured to play the virtual image related to the plot of the first video segment on the video playback interface, a display mode of the virtual image including a static display mode and a dynamic display mode.

In some embodiments, before the playback module 5551 plays the virtual image related to the plot of the first video segment, the identification module 5552 is further configured to identify a target object from the first video segment. The information recommendation apparatus 555 further includes a virtualization module 5556, which is configured to virtualize the target object, to obtain the virtual image related to the plot of the first video segment, the target object including one of the following: an object that has occurred for a longest duration in the first video segment, an object that has occurred for most times in the first video segment, and an object that has a largest quantity in the first video segment.

In some embodiments, the information recommendation apparatus 555 further includes an obtaining module 5557, which is configured to obtain feature information of the recommendation information before the playback module 5551 plays the virtual image related to the plot of the first video segment, the recommendation information being related to the plot of the first video segment, the feature information including at least one of a keyword and a recommendation topic of the recommendation information. The obtaining module 5557 is further configured to obtain the virtual image with the feature information of the recommendation information as a label, different virtual images being pre-associated with different labels.

In some embodiments, the playback module 5551 is further configured to display the first bullet comment starting from a first end of the video playback interface in response to a playback progress of the video reaching a set time point, and gradually move the first bullet comment toward a second end until being moved out of the video playback interface.

In some embodiments, the playback module 5551 is further configured to display the first bullet comment starting from a first end of the video playback interface in response to a set scene appearing in a video, and gradually move the first bullet comment toward a second end until being moved out of the video playback interface, recommendation information carried in the first bullet comment being associated with the scene, and different scenes being associated with different recommendation information.

In some embodiments, the playback module 5551 is further configured to display the first bullet comment starting from a first end of the video playback interface in response to appearance of a related object in the video that meets a matching condition with the recommendation information, and gradually move the first bullet comment toward a second end until being moved out of the video playback interface, the matching condition including: a label of the related object includes the keyword in the recommendation information, and a label of the related object includes the recommendation topic of the recommendation information.

In some embodiments, the playback module 5551 is further configured to play the video starting from a set playback progress in response to a playback progress setting operation for a timeline of the video, display the first bullet comment starting from a first end of the video playback interface, and gradually move the first bullet comment toward a second end until being moved out of the video playback interface.

In some embodiments, at least one of a moving speed, a size, and a display effect parameter of the first bullet comment is different from that of a second bullet comment, the second bullet comment being a bullet comment that does not carry the recommendation information.

The description of the apparatus in the embodiments of the present disclosure is similar to the description of the foregoing method embodiment, and has similar beneficial effects as the method embodiment. Therefore, details are not described. Technical details not mentioned in the information recommendation apparatus provided in the embodiments of the present disclosure may be understood according to the descriptions of any one of FIG. 3 to FIG. 5.

An embodiment of the present disclosure provides a computer program product, the computer program product including a computer program or a computer-executable instruction, the computer program or the computer-executable instruction being stored in a computer-readable storage medium. A processor of a computer device reads the computer-executable instruction from the computer-readable storage medium, the processor executing the computer-executable instruction, to cause the computer device to perform the foregoing information recommendation method provided in the embodiments of the present disclosure.

An embodiment of the present disclosure provides a computer-readable storage medium, having a computer-executable instruction stored therein, the computer-executable instruction, when executed by a processor, causing the processor to perform the information recommendation method in the embodiments of the present disclosure, for example, the information recommendation method shown in FIG. 3 or FIG. 5.

In some embodiments, the computer-readable storage medium may be a memory such as a ferromagnetic random access memory (FRAM), a ROM, a programmable random access memory (PROM), an erasable programmable random access memory (EPROM), an electrically erasable programmable random access memory (EEPROM), a flash memory, a magnetic surface memory, a compact disc, or a compact disc random access memory (CD-ROM), or may be various devices including one of or any combination of the foregoing memories.

In some embodiments, the executable instruction may adopt any form such as a program, a software, a software module, a script, or a code, may be written in a programming language of any form (including a compiled or interpreted language, or a declarative or procedural language), and may be deployed in any form, for example, deployed as a standalone program or as a module, a component, a subroutine, or another unit suitable for use in a computing environment.

In an example, the executable instructions may be deployed to be executed on one electronic device, or executed on a plurality of electronic devices located at one location, or executed on a plurality of electronic devices distributed at a plurality of locations and connected through a communication network.

The embodiments of the present disclosure have the following beneficial effects.

In a process of playing a video, the first bullet comment carrying the recommendation information is displayed on the video playback interface, and when the trigger operation performed by a user on the first bullet comment is identified, the first material related to the plot of the first video segment is displayed on the video playback interface, thereby enriching the representation form of the bullet advertisement, achieving an effect of mutual correlation between the advertisement and the video plot, and promoting bilateral interaction between the user and the advertisement. In other words, the technical solution provided in the embodiments of the present disclosure may reduce failure rate of information recommendation by enriching the representation form of the bullet advertisement, thereby avoiding ineffective recommendation, and then improving efficiency and accuracy of information recommendation.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing descriptions are merely embodiments of the present disclosure and are not intended to limit the protection scope of the present disclosure. Any modification, equivalent replacement, or improvement made within the spirit and principle of the present disclosure falls within the protection scope of the present disclosure.

What is claimed is:

1. An information recommendation method, performed by an electronic device, the method comprising:
playing a video on a video playback interface;
displaying a first bullet comment on the video playback interface, the first bullet comment carrying recommendation information; and
playing a first material related to a plot of a first video segment on the video playback interface in response to a trigger operation for the first bullet comment, the first video segment being a video segment in the video corresponding to a display duration of the first bullet comment.

2. The method according to claim 1, further comprising:
performing plot identification processing on the first video segment, to obtain plot information of the first video segment; and
determining, from a plurality of candidate materials, the first material that is consistent with the plot information.

3. The method according to claim 2, wherein determining the first material comprises:
encoding styles of the plurality of candidate materials respectively, to obtain a style feature vector corresponding to each of the plurality of candidate materials;
encoding the plot information of the first video segment, to obtain a plot feature vector corresponding to the first video segment;
sequentially determining a similarity between the plot feature vector corresponding to the first video segment and the style feature vector corresponding to each of the plurality of candidate materials; and
using a material corresponding to a highest similarity as the first material that is consistent with the plot information.

4. The method according to claim 1, further comprising:
identifying a target object from the first video segment, the target object comprising one of following: an object that has occurred for a longest duration in the first video segment, an object that has occurred for most times in the first video segment, and an object that has a largest quantity in the first video segment; and
using at least one of the target object and a virtualized target object as the first material related to the plot of the first video segment.

5. The method according to claim 1, further comprising:
displaying the recommendation information at a set position of the video playback interface;
adjusting a display effect parameter of the first material in response to a trigger operation for the recommendation information; and
displaying a details page of the recommendation information after playback of the first material is completed.

6. The method according to claim 5, wherein adjusting the display effect parameter of the first material comprises:
performing at least one of following:
increasing a quantity of first materials displayed on the video playback interface;
increasing a moving speed of the first material on the video playback interface;
reducing transparency of the first material on the video playback interface; or
increasing a size of the first material displayed on the video playback interface.

7. The method according to claim 1, wherein
the first video segment comprises a plurality of plot units; and
playing the first material related to the plot of the first video segment on the video playback interface comprises:
synchronously playing the first material on the video playback interface when a different plot unit of the first video segment being played, and applying, to the first material, a display effect parameter corresponding to the plot unit.

8. The method according to claim 1, wherein
the first material comprises a virtual image; and
playing the first material related to the plot of the first video segment on the video playback interface comprises:
playing the virtual image related to the plot of the first video segment on the video playback interface, a display mode of the virtual image comprising a static display mode and a dynamic display mode.

9. The method according to claim 8, further comprising:
identifying a target object from the first video segment, the target object comprising one of following: an object that has occurred for a longest duration in the first video segment, an object that has occurred for most times in the first video segment, and an object that has a largest quantity in the first video segment; and
virtualizing the target object, to obtain the virtual image related to the plot of the first video segment.

10. The method according to claim 8, further comprising:
obtaining feature information of the recommendation information, the recommendation information being related to the plot of the first video segment, the feature information comprising at least one of a keyword and a recommendation topic of the recommendation information; and
obtaining the virtual image having the feature information of the recommendation information as a label, different virtual images being pre-associated with different labels.

11. The method according to claim 1, wherein displaying the first bullet comment on the video playback interface comprises:
displaying the first bullet comment starting from a first end of the video playback interface in response to a playback progress of the video reaching a set time point, and
gradually moving the first bullet comment toward a second end until being moved out of the video playback interface.

12. The method according to claim 1, wherein displaying the first bullet comment on the video playback interface comprises:
displaying the first bullet comment starting from a first end of the video playback interface in response to a set scene appearing in a video, and
gradually moving the first bullet comment toward a second end until being moved out of the video playback interface, recommendation information carried in the first bullet comment being associated with the set scene, and different scenes being associated with different recommendation information.

13. The method according to claim 1, wherein displaying the first bullet comment on the video playback interface comprises:
displaying the first bullet comment starting from a first end of the video playback interface in response to appearance of a related object in the video that meets a matching condition with the recommendation information, and
gradually moving the first bullet comment toward a second end until being moved out of the video playback interface, the matching condition comprising: a label of the related object comprises a keyword in the recommendation information, and a label of the related object comprises recommendation topic of the recommendation information.

14. The method according to claim 1, wherein displaying the first bullet comment on the video playback interface comprises:
playing the video starting from a set playback progress in response to a playback progress setting operation for a timeline of the video,
displaying the first bullet comment starting from a first end of the video playback interface, and gradually moving the first bullet comment toward a second end until being moved out of the video playback interface.

15. The method according to claim 1, wherein
at least one of a moving speed, a size, and a display effect parameter of the first bullet comment is different from that of a second bullet comment, the second bullet comment being a bullet comment that does not carry the recommendation information.

16. An electronic device, comprising:
one or more processors; and
a memory, configured to store an executable instruction that, when being executed, causes the one or more processors to perform:
playing a video on a video playback interface;
displaying a first bullet comment on the video playback interface, the first bullet comment carrying recommendation information; and
playing a first material related to a plot of a first video segment on the video playback interface in response to a trigger operation for the first bullet comment, the first video segment being a video segment in the video corresponding to a display duration of the first bullet comment.

17. The device according to claim 16, wherein the one or more processors are further configured to perform:
performing plot identification processing on the first video segment, to obtain plot information of the first video segment; and
determining, from a plurality of candidate materials, the first material that is consistent with the plot information.

18. The device according to claim 17, wherein the one or more processors are further configured to perform:
encoding styles of the plurality of candidate materials respectively, to obtain a style feature vector corresponding to each of the plurality of candidate materials;
encoding the plot information of the first video segment, to obtain a plot feature vector corresponding to the first video segment;
sequentially determining a similarity between the plot feature vector corresponding to the first video segment and the style feature vector corresponding to each of the plurality of candidate materials; and
using a material corresponding to a highest similarity as the first material that is consistent with the plot information.

19. The device according to claim 16, wherein the one or more processors are further configured to perform:
identifying a target object from the first video segment, the target object comprising one of following: an object that has occurred for a longest duration in the first video segment, an object that has occurred for most times in the first video segment, and an object that has a largest quantity in the first video segment; and
using at least one of the target object and a virtualized target object as the first material related to the plot of the first video segment.

20. A non-transitory computer-readable storage medium, containing a computer-executable instruction that, when being executed, causes at least one processor to perform:
playing a video on a video playback interface;
displaying a first bullet comment on the video playback interface, the first bullet comment carrying recommendation information; and
playing a first material related to a plot of a first video segment on the video playback interface in response to a trigger operation for the first bullet comment, the first video segment being a video segment in the video corresponding to a display duration of the first bullet comment.
